(19) United States
(12) Patent Application Publication
(10) Pub. No.: US 2026/0310509 A1
(43) Pub. Date: Oct. 8, 2026

(54) METHOD AND SYSTEM FOR DYNAMIC ALLOCATION AND MONITORING OF COMPUTING RESOURCES IN CONTAINERIZED ENVIRONMENTS FOR MACHINE LEARNING TRAINING COST OPTIMIZATION

(71) Applicant: Vessl AI Korea Inc., Gwangju (KR)

(72) Inventors: Ji Hwan CHUN, Seongnam-si (KR); Yong Seon LEE, Suwon-si (KR); Gi Sung PARK, Yongin-si (KR)

(73) Assignee: Vessl AI Korea Inc., Gwangju (KR)

(21) Appl. No.: 19/302,343

(22) Filed: Aug. 18, 2025

(30) Foreign Application Priority Data
Apr. 7, 2025 (KR) 10-2025-0044588

(51) Int. Cl. G06F 9/50

(52) U.S. Cl. CPC G06F 9/5027

(57) ABSTRACT

Disclosed is a method for dynamic allocation of a computing resource in a containerized environment for machine learning training cost optimization, which is performed by a machine learning operations system. The method includes selecting, at a user, predefined computing resource settings to request a machine learning task, generating, at a machine learning platform, a job specification depending on the request of the machine learning task, periodically querying, at a cluster agent integrating with the machine learning platform, the job specification, dynamically generating a computing resource through a container-based orchestration system, and allocating and scheduling a resource necessary for the job specification, and checking, at the machine learning platform, a cumulative computing resource usage of the user or an organization associated with the user in real time, determining whether the machine learning task is executable by comparing the cumulative computing resource usage with a preset usage limit, and granting or rejecting execution of the machine learning task based on a result of the determination.

### CROSS-REFERENCE TO RELATED APPLICATIONS

This application claims priority under 35 U.S.C. § 119 to Korean Patent Application No. 10-2025-0044588 filed on Apr. 7, 2025, in the Korean Intellectual Property Office, the disclosures of which are incorporated by reference herein in their entireties.

### BACKGROUND

Embodiments of the present disclosure described herein relate to a machine learning operations (MLOps) system, and more particularly, relate to a method and a system for dynamic computing resource allocation in a containerized environment, which are capable of dynamically allocating a computing resource necessary for a machine learning task, monitoring the usage, and controlling execution depending on whether a condition is satisfied, in a container-based computing resource environment, by applying a resource usage policy in units of user/organization.

With the development of machine learning (ML) and artificial intelligence (AI) technologies, solutions using the ML and AI technologies are being actively developed in various industries. The importance of a machine learning operations (MLOps) platform is increasing to efficiently manage the development, deployment, and operation of ML/AI models.

The MLOps platform provides an integrated environment which manages the entire lifecycle of the ML/AI models, including data preparation, model training, evaluation, deployment, monitoring, etc. This allows data scientists and ML engineers to focus on model development, and companies may improve the productivity and quality of ML/AI projects.

In the MLOps environment, there is commonly adopted a structure in which a resource for a machine learning task which the user request is generated through a container-based orchestration system (e.g., Kubernetes) and a task is automatically deployed and executed.

However, a policy-based resource restriction function is absent from a conventional resource allocation system, making it difficult to control the resource usage in units of user or organization and allowing a specific user to excessively monopolize a resource.

Without determining, in advance, whether the resource usage exceeds the resource usage limit, a resource generation request is sent to the orchestration system, that is, unconditional resource generation is attempted before resource availability is determined. In this case, failure costs are repeatedly incurred.

In addition, there are task management and monitoring issues such as insufficient resource use monitoring and control for a running task and lack of an automatic recovery and review flow for task failure or a waiting state.

Prior art document related to the present disclosure includes Korean Patent Publication No. 10-2012-0017381 (2012 Feb. 28).

### SUMMARY

Embodiments of the present disclosure provide a method and a system for dynamic computing resource allocation in containerized environments for machine learning training cost optimization, which is capable of maximizing the efficiency of resource management through a resource management method capable of determining, in advance, whether or not of resource allocation based on a computing resource usage limit policy in units of user/organization unit.

Embodiments of the present disclosure provide a method and a system for dynamic computing resource allocation in containerized environments for machine learning training cost optimization, which is capable of providing a policy-based flow by automatically registering a task in a task queue in the case of exceeding a resource usage limit or when a condition is not satisfied and supporting automatic execution when a condition is satisfied.

Embodiments of the present disclosure provide a method and a system for dynamic computing resource allocation in containerized environments for machine learning training cost optimization, which is capable of providing a function of periodically monitoring a resource usage of a running task and taking control measures such as warning, pause, or resource restriction in the case of exceeding the set limit.

Embodiments of the present disclosure provide a method and a system for dynamic computing resource allocation in containerized environments for machine learning training cost optimization, which is capable of automatically collecting log and metric data generated in the process of executing a workload and using the collected data for resource usage history analysis, policy improvement, and cost prediction.

Embodiments of the present disclosure provide a method and a system for dynamic computing resource allocation in containerized environments for machine learning training cost optimization, which is capable of providing a policy-based resource access control mechanism capable of automatically granting or blocking an access request of a user of any other organization depending on an access control policy set by a cluster registration organization.

Problems to be solved by the present disclosure are not limited to the above problems, and other problems not mentioned herein may be clearly understood from the specification and the accompanying drawings by one skilled in the art to which the present disclosure pertains.

According to an aspect of the present disclosure, a method for dynamic allocation of a computing resource in a containerized environment for machine learning training cost optimization, which is performed by a machine learning operations system, may include selecting, at a user, predefined computing resource settings to request a machine learning task, generating, at a machine learning platform, a job specification depending on the request of the machine learning task, periodically querying, at a cluster agent integrating with the machine learning platform, the job specification, dynamically generating a computing resource through a container-based orchestration system, and allocating and scheduling a resource necessary for the job specification, and checking, at the machine learning platform, a cumulative computing resource usage of the user or an organization associated with the user in real time, determining whether the machine learning task is executable by comparing the cumulative computing resource usage with a preset usage limit, and granting or rejecting execution of the machine learning task based on a result of the determination.

According to an aspect of the present disclosure, when the task execution is rejected, the method may further include registering, at the machine learning platform, the machine learning task at a task queue, periodically again checking an available state of the resource and a set policy condition, and directing the execution of the machine learning task through the cluster agent when a condition is satisfied.

According to an aspect of the present disclosure, the method may further include periodically collecting, at the machine learning platform, a resource usage of a running machine learning task, and pausing the running machine learning task or sending a warning message to the user when the collected usage exceeds the preset usage limit.

According to an aspect of the present disclosure, the method may further include converting, at the cluster agent, the job specification in a resource format of the container-based orchestration system, and deploying a converted resource on an available node in a compute cluster.

According to an aspect of the present disclosure, the method may further include collecting, at an auxiliary collection module deployed on a task container in the compute cluster, a task execution log and a computing resource metric so as to be sent to the cluster agent through a central collector, and sending, at the cluster agent, the task execution log and the computing resource metric to the machine learning platform.

According to an aspect of the present disclosure, the method may further include analyzing and providing, at the machine learning platform, collected log and metric data such that the user or a manager visually checks a resource usage history and cost prediction information.

According to an aspect of the present disclosure, the method may further include performing, at the machine learning platform, an automated resource control procedure including task queue registration, execution restriction, condition review, and scheduling, in association with a task request exceeding a resource usage limit of the user or the organization.

According to an aspect of the present disclosure, the method may further include setting, at an organization registering a compute cluster, an access control policy for restricting or permitting a resource access of another organization to the machine learning platform, and granting or blocking, at the machine learning platform, a task request of a user of the another organization depending on the policy.

According to an aspect of the present disclosure, a machine learning operations system which performs dynamic computing resource allocation in a containerized environment for machine learning training cost optimization may include a machine learning platform that receives a request for a machine learning task of a user and generates a job specification for the machine learning task based on predefined computing resource settings, a cluster agent that integrates with the machine learning platform, periodically queries the job specification, dynamically generates a computing resource through a container-based orchestration system, and allocates a resource necessary for the job specification so as to be scheduled to an available node of a compute cluster, and a metric collector that periodically collects a resource usage state of the compute cluster so as to be sent to a backend server. The machine learning platform may collect, in real time, information about a cumulative computing resource usage of the user or an organization to which the user belongs, may determine whether the task is executable by comparing the cumulative computing resource usage with a preset resource usage limit, and may grant or reject execution of the machine learning task based on a result of the determination.

According to an aspect of the present disclosure, a non-transitory computer-readable recording medium may be coupled to a computer, which is hardware, and may store a computer program which performs the method for dynamic allocation of the computing resource in the containerized environment for machine learning training cost optimization.

Technical solutions of the present disclosure are not limited to the above solutions, and solutions which are not mentioned will be clearly understood by one skilled in the art to which the present disclosure pertains from the specification and the accompanying drawings.

### BRIEF DESCRIPTION OF THE FIGURES

The above and other objects, features and advantages of the present disclosure will become more apparent to those of ordinary skill in the art by describing exemplary embodiments thereof in detail with reference to the accompanying drawings.

FIG. 1 is a block configuration diagram illustrating a configuration of a machine learning operations system according to an embodiment of the present disclosure.

FIG. 2 is a conceptual diagram illustrating an architecture of a machine learning operations system according to an embodiment of the present disclosure.

FIG. 3 is a block diagram illustrating a configuration of a computing device for machine learning operations according to an embodiment of the present disclosure.

FIG. 4 is a sequence diagram illustrating a user compute cluster authentication process using a unique one-time token according to an embodiment of the present disclosure.

FIG. 5 is a sequence diagram illustrating a process in which a task execution command of a user is scheduled to a compute cluster, according to an embodiment of the present disclosure.

FIG. 6 is a sequence diagram illustrating a monitoring data collection process and a process in which monitoring data are transmitted to a machine learning operations platform, according to an embodiment of the present disclosure.

FIG. 7 is a flowchart describing a method for machine learning operations in a private network environment according to an embodiment of the present disclosure.

FIG. 8 is a flowchart describing a method for dynamic allocation of computing resources in containerized environments for machine learning training cost optimization, according to an embodiment of the present disclosure.

FIG. 9 is a sequence diagram illustrating a method for registration and management of predefined resource settings for dynamic computing resource allocation, according to an embodiment of the present disclosure.

FIG. 10 is a sequence diagram illustrating a resource allocation method using predefined resource settings for dynamic computing resource allocation, according to an embodiment of the present disclosure.

FIG. 11 is a sequence diagram illustrating a method of checking a usage limit before resource generation for dynamic computing resource allocation, according to an embodiment of the present disclosure.

FIG. 12 is a sequence diagram illustrating a method of monitoring and limiting a workload usage for dynamic computing resource allocation, according to an embodiment of the present disclosure.

FIG. 13 is a sequence diagram illustrating a deployment waiting method using a task queue for dynamic computing resource allocation, according to an embodiment of the present disclosure.

FIG. 14 is a sequence diagram illustrating a log and metric collection and transmission method for dynamic computing resource allocation, according to an embodiment of the present disclosure.

FIG. 15 is a sequence diagram illustrating an organization-specific access control method for dynamic computing resource allocation, according to an embodiment of the present disclosure.

FIG. 16 is a flowchart illustrating a resource pre-reservation allocation method for dynamic computing resource allocation, according to an embodiment of the present disclosure.

### DETAILED DESCRIPTION

Specific structural or functional descriptions which are described in the specification in association with various embodiments according to the present disclosure are provided only for the purpose of describing embodiments according to the present disclosure, and the embodiments according to the present disclosure may be carried out in various different forms, not limiting the embodiments described in the specification.

Because the embodiments according to the present disclosure are susceptible to various modifications and alternative forms, the embodiments will be shown as an example in the drawings and will be described in detail in the specification. However, the embodiments according to the present disclosure include modifications, equivalents, and alternatives falling within the spirit and scope of the present disclosure, not limiting the embodiments according to the present disclosure to particular forms disclosed herein.

Even though the terms “first”, “second”, etc. may be used to describe various components, the components should not be construed as being limited by the terms. These terms are only used to distinguish one element from another. For example, a first element may be termed a second element, and, similarly, the second element may be termed the first element, without departing from the scope of the present disclosure.

It should be understood that when a first component is referred to as being “connected” or “coupled” to a second component, the first component may be directly connected or coupled to the second component or intervening components may be present therebetween. In contrast, when a component is referred to as being “directly connected” or “directly coupled” to another component, it should be understood that any other component is not interposed therebetween. Expressions used to describe relationships between components, for example, “between” versus “directly between”, “adjacent” versus “directly adjacent,” etc. should be interpreted in a like fashion.

The terms used herein are only to describe specific embodiments and are not intended to limit the present disclosure. The articles “a”, “an”, and “the” are singular in that they have a single referent, but the use of the singular form should not preclude the presence of more than one referent. In the specification, it should be understood that the terms “comprises”, “comprising”, “includes”, “including”, etc. specify that described features, numbers, steps, operations, components, or parts or a combination thereof exists, but do not preclude the presence or addition of one or more other features, numbers, steps, operations, components, or parts or a combination thereof.

Unless otherwise defined, all terms including technical and scientific terms used herein have the same meaning as commonly understood by one of ordinary skill in the art to which the present disclosure pertains. It will be further understood that terms defined in commonly used dictionaries should be interpreted as having a meaning consistent with their meaning in the context of the related art and will not be interpreted in an idealized or overly formal sense unless expressly so defined herein.

In the specification, a processor may refer to hardware capable of performing a function and an operation according to each name described in the specification, may refer to a computer program code capable of performing a specific function and a specific operation, or may refer to an electronic recording medium equipped with a computer program code capable of performing a specific function and a specific operation.

In other words, the processor may refer to a functional and/or structural combination of hardware for carrying out the technical idea of the present disclosure and/or software for driving the hardware.

Below, embodiments will be described in detail with reference to the accompanying drawings. However, the scope of the patent application is neither limited nor restricted by the embodiments. The same reference numerals/signs in the drawings denote the same members.

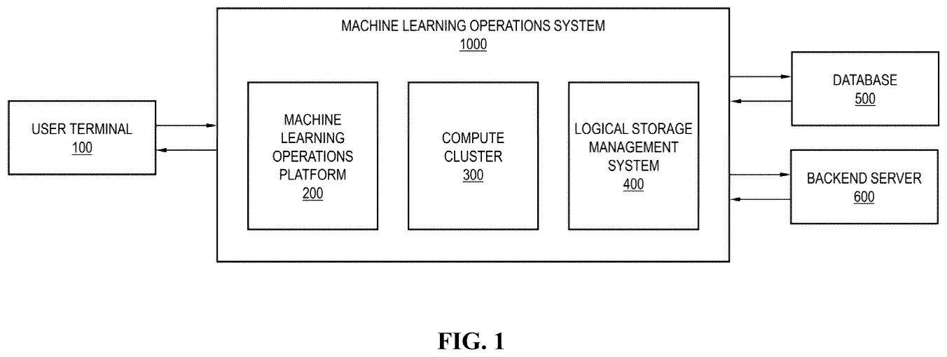

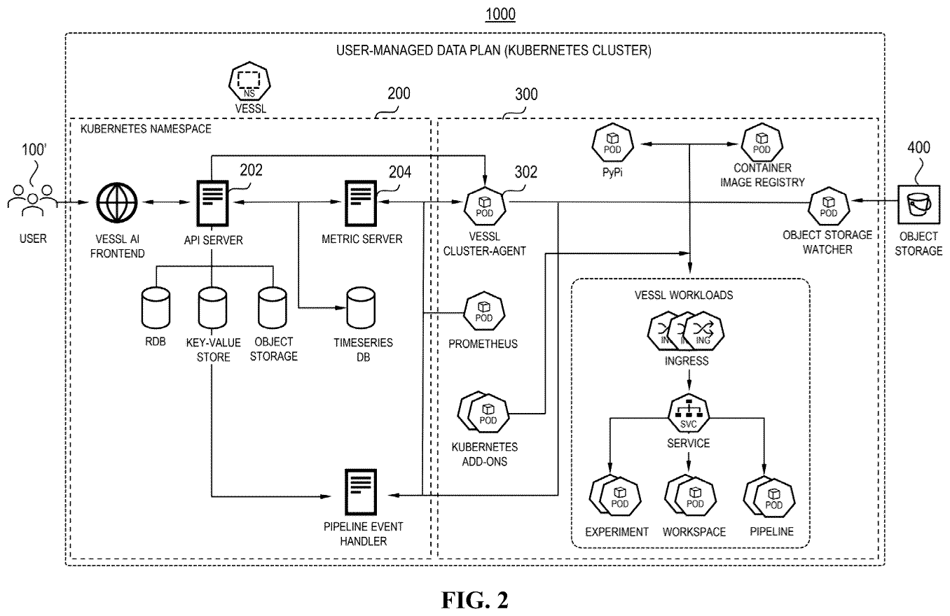

FIG. 1 is a block configuration diagram describing a configuration of a machine learning operations system, according to an embodiment of the present disclosure, and FIG. 2 is a conceptual diagram illustrating an architecture of a machine learning operations system, according to an embodiment of the present disclosure.

Referring to FIGS. 1 and 2, a machine learning operations system 1000 according to an embodiment of the present disclosure interworks with a user terminal 100. The user may connect to the machine learning operations system 1000 through the user terminal 100 and may user machine learning operations and logical storage operations functions which the machine learning operations system 1000 provides.

The machine learning operations system 1000 may include a machine learning operations platform 200 corresponding to a control plane, a compute cluster 300 corresponding to a data plane capable of being operated on the infrastructure of the user terminal 100, and a logical storage management system 400 which logically integrates and manages a variety of storage present inside/outside the machine learning operations system 1000.

According to an embodiment of the present disclosure, the machine learning operations platform 200 may be a machine learning operations (MLOps) platform or a large language model operations (LLMOps) platform or may be implemented as a partial function of the platform. According to an embodiment, the machine learning operations system 1000 and/or the machine learning operations platform 200 is capable of being implemented as a machine learning operations (MLOps) environment or a large language model operations (LLMOps) environment. Alternatively, the machine learning operations system 1000 and/or the machine learning operations platform 200 is also capable of being applied to various application environments or platforms based on a machine learning operations (MLOps) environment or a large language model operations (LLMOps) environment.

The machine learning operations platform 200 which is a platform for automating and managing the entire lifecycle including development, deployment and operations of a machine learning model and may directly provide core functions of machine learning, services, and computational resource allocation to the user terminal 100. The machine learning operations platform 200 may perform functions such as user authentication, machine learning task scheduling, machine learning model version management, and experiment tracking. In an embodiment, the machine learning operations platform 200 may communicate with the user terminal 100 and the compute cluster 300 through a RESTful API (Representational State Transfer Application Programming Interface, REST API).

The machine learning operations platform 200 may include an API server 202. The API server 202 may execute business logic of the machine learning operations platform 200. The API server 202 may provide an interface which directly communicates with the user terminal 100 by using a method such as a world wide web (Web), a command line interface (CLI), and/or a software development kit (SDK). In addition to the API server 202, the machine learning operations platform 200 may further include a metric server 204 which stores and queries logs, metrics, and/or files generated from workloads, a database, etc.

In an embodiment of the present disclosure, the computational resource may be established in the form of a cluster. According to an embodiment of the present disclosure, the compute cluster 300 may be a component which the user terminal 100 holds and is established in the private network environment. The computational resource includes hardware resources, which are necessary at respective stages of the machine learning lifecycle, such as a central processing unit (CPU), a graphic processing unit (GPU), a memory, and a storage may be implemented in the compute cluster 300. The compute cluster 300 may execute the actual ML/AI workload. According to an embodiment, the compute cluster 300 may be implemented based on a container and may be managed by using the Kubernetes.

The compute cluster 300 may include a cluster agent 302. The compute cluster 300 may communicate with the machine learning operations platform 200 through the cluster agent 302.

As a key component installed in the compute cluster 300, the cluster agent 302 is a subject which manages the compute cluster 300. The cluster agent 302 may serve to communicate with the machine learning operations platform 200. The cluster agent 302 may perform functions such as machine learning task execution, status report, and computational resource monitoring. In detail, the cluster agent 302 may control and determine how to execute a machine learning task which the user requests, how to report the status of machine learning tasks in the compute cluster 300 to the user terminal 100, how to monitor an allocation present situation of the computational resource for the machine learning task, etc. According to an embodiment of the present disclosure, because most of the data necessary for machine learning includes sensitive information which should not be exposed to the outside, the compute cluster 300 is in a state of being set to use only the outbound connection. In other words, the compute cluster 300 according to an embodiment of the present disclosure may be implemented with a network in which the outbound traffic is permitted and the inbound traffic is not permitted. According to the above description, the security of the machine learning operations system 1000 according to an embodiment of the present disclosure may be reinforced. Due to the above characteristic of the compute cluster 300, the user terminal 100 communicates only through the machine learning operations platform 200, and the cluster agent 302 operates to schedule and control the machine learning task to the computational resource in the compute cluster 300 depending on a request of the user

The logical storage management system 400 may logically integrate a variety of storage and may manage the variety of storage through one integrated interface.

The logical storage management system 400 may inherently process various access mechanisms and various authentication manners of not only cloud storage such as AWS S3 and GCS but also on-premise storage such as NFS and HostPath-based local disk, and thus, the user may conveniently use a variety of dispersed storage as one storage.

The logical storage management system 400 may abstract APIs for various types of storage such as AWS S3 (Amazon Simple Storage Service), GCS (Google Cloud Storage), NFS (Network File System), and local disk into a single integrated interface, which provides easy storage interworking and management to the user.

The logical storage management system 400 may provide a one-to-many relationship volume management function. That is, an architecture capable of easily generating a plurality of volumes during interworking with one storage may be provided, which enables management and reuse of data at detailed file unit.

The logical storage management system 400 may provide the portability to seamlessly import and export data required to execute a workload in a cluster in both cloud and on-premise environments, and thus, cloud and on-premise interworking may be optimized.

The logical storage management system 400 may support automatic data loading and automatic save or export of learning results through Python SDK, CLI, and YAML settings in the process of driving a workload container, thus simplifying an ML workflow and improving a processing speed.

The database 500 may function as central information storage which stores information about a user, an organization, a cluster, resource settings, a policy condition, a resource usage history, and task status. The database 500 is illustrated in FIG. 1 as being implemented separately from the machine learning operations system 1000, but the present disclosure is not limited thereto. For example, according to an embodiment, the database 500 may be built and operated in the machine learning operations system 1000.

A backend server 600 may operate as a key module of policy determination and execution control, which analyzes real-time resource usage data received from a resource manager and a metric collector and compares an analysis result with a resource usage limit and a policy condition of a user or organization stored in the database 500 to determine whether a task is executable or whether to exceed a resource in association with the running task. In addition, the backend server 600 may register or review a task not satisfying the condition at a task queue and may process the task not satisfying by referring to policy information stored in the database 500 when determining an access control policy. The backend server 600 is illustrated in FIG. 1 as being implemented separately from the machine learning operations system 1000, but the present disclosure is not limited thereto. For example, according to an embodiment, a computing resource in the machine learning operations system 1000 may be allocated to perform the function of the backend server 600.

The machine learning operations system 1000 according to an embodiment of the present disclosure may integrally implement a policy-based autonomous decision-making system and a dynamic resource control structure, in association with all processes, which are necessary to execute a user request-based machine learning task, such as resource settings, allocation, execution, monitoring, and control. For example, the machine learning operations system 1000 may determine whether it is possible to allocate a resource depending on a predefined resource usage policy, may automatically execute an execution-limited task through a task queue-based review flow when a condition is satisfied, may continuously monitor the resource usage even during execution, and may perform a control operation, such as warning, restriction/limitation, and pause, when violating the policy.

Also, as the machine learning operations system 1000 according to an embodiment of the present disclosure systematically collects log and metric data through an auxiliary collection module and a central collector and prevents conflicts between cluster resources in a multi-tenancy environment based on an inter-organization resource access policy, the machine learning operations system 1000 may implement a machine learning platform infrastructure capable of simultaneously enhancing efficiency of resource usage, policy-based automation, operation reliability, and security.

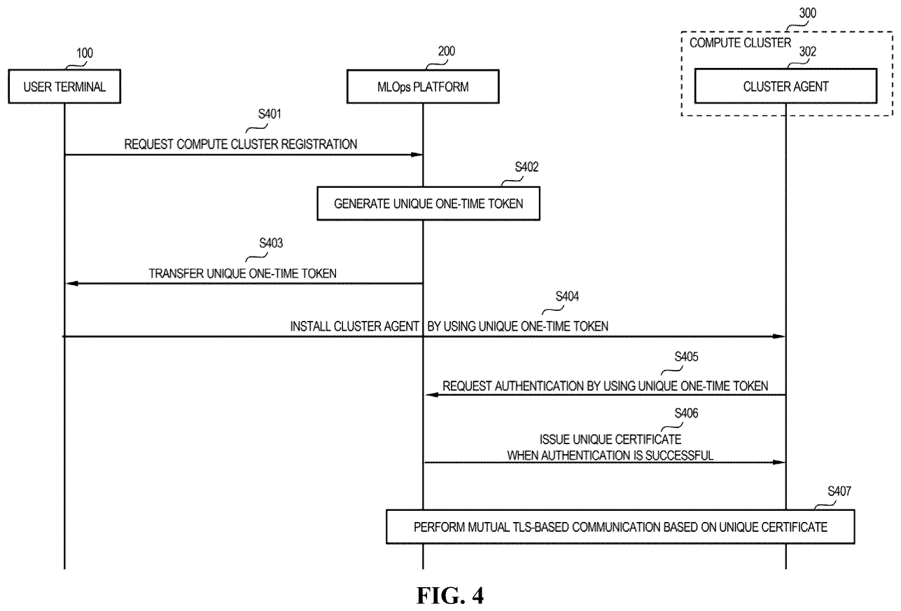

The security mechanism of the machine learning operations system 1000 according to an embodiment of the present disclosure may be implemented by encrypting all communications in the machine learning operations system 1000 through the HTTPS (Hypertext Transfer Protocol Secure), using mutual transport layer security (mTLS) communication, and verifying the validity of each request by using a token-based authentication system. This will be described with reference to FIG. 4.

The security mechanism of the machine learning operations system 1000 according to an embodiment of the present disclosure may be implemented by allowing the cluster agent 302 to periodically perform polling on the machine learning operations platform 200 to check a new machine learning task or a command from the user 100.

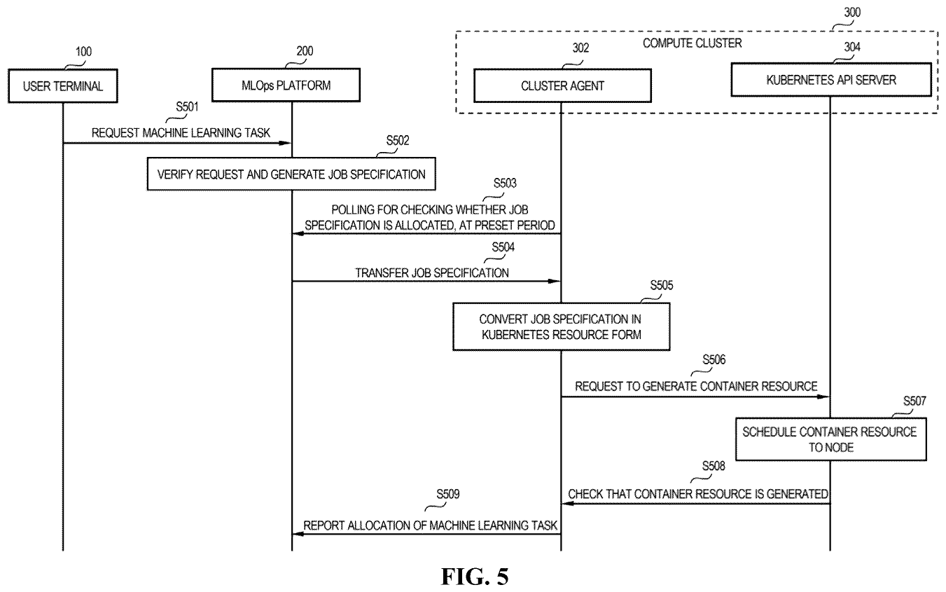

In detail, because the compute cluster 300 according to an embodiment of the present disclosure uses only the outbound connection from the internal network to the outside, it is impossible for the machine learning operations platform 200 to instruct the machine learning task directly to the compute cluster 300. In this case, according to an embodiment of the present disclosure, to perform the machine learning task with the computational resource which the user terminal 100 holds, the cluster agent 302 included in the compute cluster 300 may perform polling on the machine learning operations platform 200 based on a preset period and may determine whether a job specification for the machine learning task is allocated. This will be described with reference to FIG. 5.

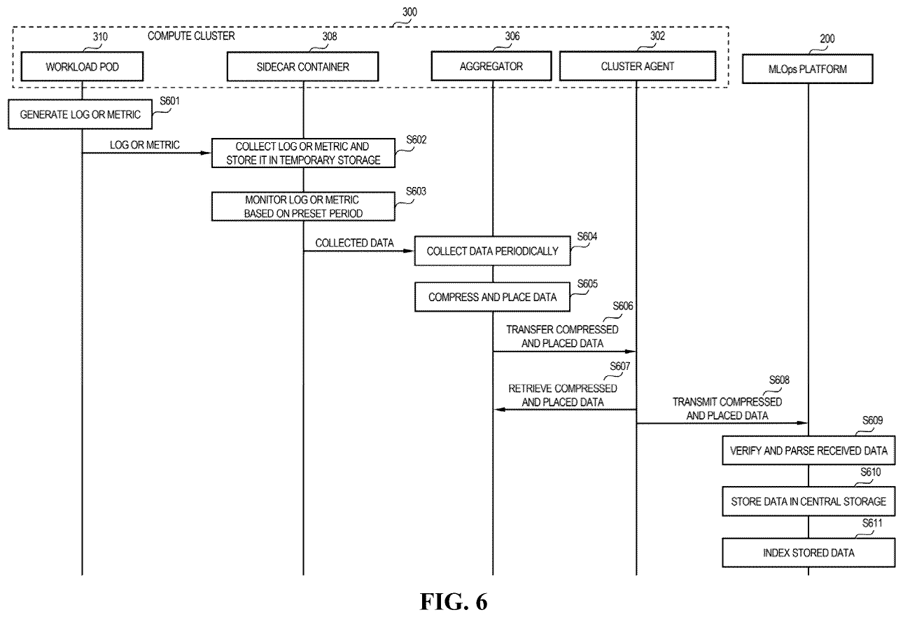

The machine learning operations system 1000 according to an embodiment of the present disclosure may dynamically allocate and monitor the computational resource. In detail, a resource manager which is installed at each node of the compute cluster 300 may monitor, in real time, usage amounts of resources such as a CPU, a memory, and a GPU. Monitoring data (e.g., logs and/or metrics) collected in the compute cluster 300 may be stored in real time through a Prometheus component and may be periodically reported to the machine learning operations platform 200. A scheduler of the machine learning operations platform 200 may perform optimal resource allocation determination, based on the monitoring data periodically reported to the machine learning operations platform 200. A sidecar container may be together distributed to each workload and may collect monitoring data including logs or metrics. After the collected monitoring data are buffered in a local temporary storage, the collected monitoring data may be compressed or placed in an aggregator so as to be transmitted to the machine learning operations platform 200. This will be described with reference to FIG. 6.

For data security and regulatory compliance, the machine learning operations system 1000 according to an embodiment of the present disclosure may support the flexible establishment of a machine learning operations platform at the cloud level even in an on-premise environment. According to the above description, the machine learning operations system 1000 according to an embodiment of the present disclosure may improve container-based ML/AI project productivity and quality through efficient allocation and monitoring of a special hardware resource such as a GPU. Also, the machine learning operations system 1000 according to an embodiment of the present disclosure may reinforce security through auto-generated one-time tokens and mutual TLS authentication and may overcome restrictions on network security policies by using only the outbound connection. In addition, the machine learning operations system 1000 according to an embodiment of the present disclosure may optimize machine learning costs through a real-time resource monitoring and dynamic allocation system in the container environment. Furthermore, the machine learning operations system 1000 according to an embodiment of the present disclosure may effectively collect various indicators and logs by utilizing the cluster agent and the sidecar container and may provide the collected indicators and logs to the user, and thus, performance or indicator monitoring and maintenance of the machine learning model may become easier.

The machine learning operations system 1000 according to an embodiment of the present disclosure may automate and optimize a data access required for an ML workload while integrally managing various types of storage backends with a single interface. To this end, the machine learning operations system 1000 may integrate a plurality of external storage (AWS S3, GCS, NFS, local disk, etc.) with a single interface to register and set up logical storage; in this case, it may be possible to provide a space accessible through a POSIX (Portable Operating System Interface) file system interface inside the ML workload container such that a volume for the logical storage is registered and set up. The volume may provide an import function to fetch a file from target storage, an export function to again apply changes to the target storage after use completion, and/or a mount function to mount a specific directory to a volume during execution. The volume with the specific directory mounted can be utilized like a local volume.

The machine learning operations system 1000 according to an embodiment of the present disclosure disclosed in FIGS. 1 and 2 is described under the condition that the compute cluster 300 and the logical storage management system 400 are independent of each other, and this is provided for convenience of description. For example, the compute cluster 300 and the logical storage management system 400 may be implemented such that at least some function are shared or are integrated as one function element.

For example, the logical storage management system 400 may include a logical storage agent for logical storage setup and allocation, and the logical storage agent may be integrally implemented with a cluster agent of a compute cluster. That is, in the present disclosure, each component is functionally classified and described for convenience of description. According to an embodiment, it is possible to integrate components or to use some functions in common.

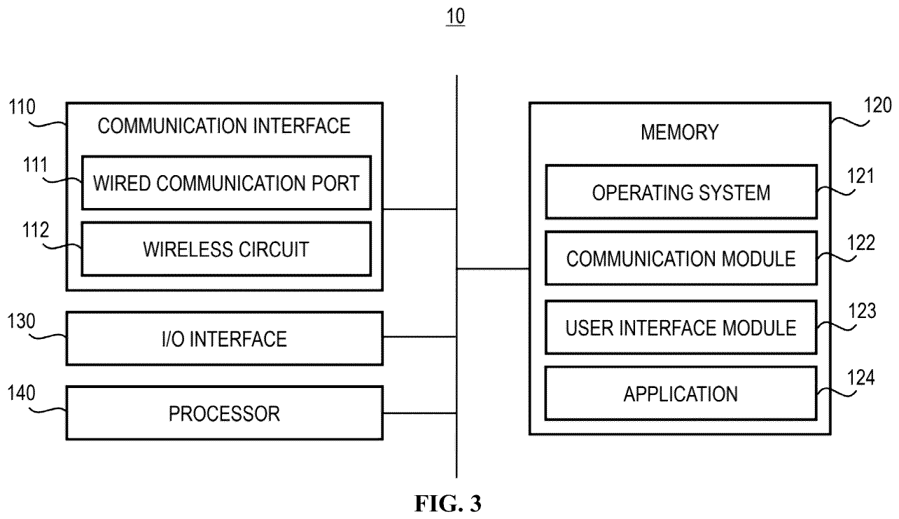

FIG. 3 is a block diagram illustrating a configuration of a computing device for machine learning operations, according to an embodiment of the present disclosure.

Referring to FIG. 3, a computing device 10 for machine learning operations may be a server which provides a machine learning operations service depending on a request of a user (or a user device) or a user device in which a web page, an application, and/or a program capable of performing machine learning operations is installed and executed.

The computing device 10 for machine learning operations may include a communication interface 110, a memory 120, an I/O interface 130, and/or a processor 140, which communicate with each other through one or more communication buses or signal lines.

The communication interface 110 may connect to a user device (not illustrated) over a wired/wireless communication network to exchange data. For example, when the computing device 10 for machine learning operations is a server, the communication interface 110 may receive a machine learning task command or a compute cluster registration request from the user device. Also, the communication interface 110 may transmit monitoring data including logs and/or metrics to the user. The monitoring data which are transmitted to the user may be data obtained by performing “compressing and placing” and indexing on logs and/or metrics.

Meanwhile, the communication interface 110 which enables the transmission/reception of data may include a wired communication port 111 and a wireless circuit 112. Herein, the wired communication port 111 may include one or more wired interfaces, for example, Ethernet, universal serial bus (USB), IEEE1394 (e.g., FireWire, Apple: i.Link, Sonny: Lynx, Texas Instrument), etc. Also, the wireless circuit 112 may transmit/receive data to/from an external device through a radio frequency (RF) signal or an optical signal. Furthermore, the wireless communication may use at least one of a plurality of communication standards, protocols, and technologies, for example, global system for mobile communications (GSM), enhanced data rates for GSM evolution (EDGE), code-division multiple access (CDMA), time division multiple access (TDMA), Bluetooth, Wi-Fi, VOIP, Wi-MAX, or any other appropriate communication protocol.

The memory 120 may store a variety of data which are used in the computing device 10 for machine learning operations. For example, the memory 120 may store logs, metrics, system metrics, and/or metadata of files, which are generated from workloads. For another example, the memory 120 may store data which the cluster agent 302 collects in the compute cluster 300 according to an embodiment of the present disclosure. Also, the memory 120 may store a collection code directly written by the user or data stored in an automatic upload directory.

In various embodiments, the memory 120 may include a volatile or nonvolatile recording medium capable of storing various kinds of data, commands, and/or information. For example, the memory 120 may include a storage medium of at least one type among the following types: a flash memory type, a hard disk type, a multimedia card micro type, a card type memory (e.g., an SD or XD memory), a random access memory (RAM), a static RAM (SRAM), a read-only memory (ROM), a programmable ROM (PROM), an electrically erasable programmable ROM (EEPROM), network storage, cloud, and a blockchain database.

In various embodiments, the memory 120 may store at least one of an operating system 121, a communication module 122, a user interface module 123, and one or more applications 124.

The operating system 121 (e.g., an embedded operating system such as LINUX, UNIX, MAC OS, WINDOWS, or VxWorks) may include various software components and drivers for controlling and managing general system jobs (e.g., memory management, storage device control, and power management) and may support communication between various hardware, firmware, and software components.

The communication module 122 may support communication with any other device through the communication interface 110. The communication module 122 may include various software components for processing data received by the wired communication port 111 or the wireless circuit 112 of the communication interface 110.

The user interface module 123 may receive a request or an input of the user from a keyboard, a touchscreen, a keyboard, a mouse, and/or a microphone through the I/O interface 130 and may provide a user interface on a display.

The application 124 may include a program or a module which is configured to be executable by one or more processors 140. Herein, an application which provides a service for processing all stages necessary for machine learning research and development, including machine learning, machine learning model distribution, monitoring, and/or computational resource scheduling, may be implemented on a server farm.

The I/O interface 130 may connect an input/output device (not illustrated) of the computing device 10 for machine learning operations, for example, at least one of a display, a keyboard, a touchscreen, and a microphone with the user interface module 123. The I/O interface 130 may receive a user input (e.g., a voice input, a keyboard input, or a touch input) together with the user interface module 123 and may process a command according to the received input.

The processor 140 may be connected to the communication interface 110, the memory 120, and the I/O interface 130 to control all operations of the computing device 10 for machine learning operations and may perform various commands for machine learning operations through the application and/or the program stored in the memory 120.

The processor 140 may correspond to a computing device such as a central processing unit (CPU) or an application processor (AP). Also, the processor 140 may be implemented in the form of an integrated chip (IC) such as a system on chip (SoC) in which various computing devices are integrated. In addition, the processor 140 may include a module for calculating an artificial neural network model such as a neural processing unit (NPU).

Various embodiments of a machine learning operations method which is performed by the machine learning operations system 1000 will be described with reference to FIGS. 4 to 7.

FIG. 4 is a sequence diagram illustrating a process in which a compute cluster of a user is authenticated by using a unique one-time token, according to an embodiment of the present disclosure.

Referring to FIG. 4, there is illustrated a process in which the user terminal 100 installs the cluster agent 302 on the compute cluster 300 through the MLOps platform 200 and performs authentication and interworking on the compute cluster 300 by using a unique one-time token which the MLOps platform 200 generates. In FIG. 4, the MLOps platform 200 may be an example of a machine learning operations platform 200 of FIG. 1.

For security reasons, the MLOps platform 200 needs to authenticate only the compute cluster 300 issuing an explicit command for a computational resource which the user wants to use. According to an embodiment of the present disclosure, the corresponding compute cluster 300 may be initially authenticated only once depending on the request of the user, and afterwards, the corresponding compute cluster 300 may be determined as an authenticated cluster, and the user may continuously perform communication with the corresponding compute cluster 300 through the MLOps platform 200.

Referring to FIG. 4, the user terminal 100 may request a new compute cluster registration request from the MLOps platform 200 (S401).

In response to the request of the user, the MLOps platform 200 may generate a unique one-time token (S402) and may transfer the generated unique one-time token to the user 100 (S403).

The user terminal 100 may install the cluster agent 302 on the compute cluster 300 of the user terminal 100 by using the received unique one-time token (S404). Herein, the user terminal 100 may access the compute cluster 300 solely at an installation step S404 of the entire service operation to declare that the corresponding compute cluster 300 is a cluster dependent on the MLOps platform 200 and to transfer a relevant token to the corresponding compute cluster 300.

During initial booting, the cluster agent 302 may request authentication of the cluster agent 302 to the MLOps platform 200 by using the unique one-time token which the user terminal 100 transfers (S405).

When the MLOps platform 200 authenticates the cluster agent 302, that is, when the cluster agent 302 succeeds in authentication, the MLOps platform 200 may issue a unique certificate to the cluster agent 302 (S406).

Mutual TLS-based communication can be performed between the MLOps platform 200 and the cluster agent 302 based on the unique certificate.

FIG. 5 is a sequence diagram illustrating a process in which a job execution command of a user is scheduled to a compute cluster, according to an embodiment of the present disclosure.

Referring to FIG. 5, there is illustrated a process in which a job execution command which the user terminal 100 gives through the MLOps platform 200 is scheduled to the compute cluster 300 of the user. In FIG. 5, the MLOps platform 200 may be an example of a machine learning operations platform 200 of FIG. 1.

Referring to FIG. 5, the user 100 may request a machine learning task (e.g., machine learning model training) by using a web user interface (UI) or a command-line interface (CLI) (S501).

The MLOps platform 200 may verify the request received from the user terminal 100 and may generate a job specification according to the request (S502). The generated job specification may be stored in an internal database of the MLOps platform 200.

In this case, the step of verifying the request received from the user terminal 100 may be, for example, a step of checking whether the received request is a request to execute a process that the MLOps platform (200) can schedule, whether a computational resource for performing a corresponding task is sufficient, whether the user terminal 100 requests a task which uses data actually accessible by the compute cluster 300, whether a command which the user terminal 100 intends to execute is error-free, etc. The step of verifying the request received from the user terminal 100 may be a step of performing first verification at the MLOps platform 200 for security. Because the compute cluster 300 is set to use only the outbound connection, it is impossible for the MLOps platform 200 to directly request the machine learning task, which is based on the job specification, from the cluster agent 302. The stored job specification and machine learning task request may be transferred to the compute cluster 300 through subsequent steps including step S503.

To check whether the job specification is allocated, the cluster agent 302 may perform polling on the MLOps platform 200 depending on a preset period (e.g., 15 seconds) (S503). As the cluster agent 302 performs polling periodically, the cluster agent 302 may check if there are any job specification not yet allocated on the MLOps platform 200 exists.

At polling of a specific time point, when a job specification not yet allocated exists, the MLOps platform 200 may transfer the job specification not yet allocated to the cluster agent 302 (S504).

The cluster agent 302 may analyze the transferred job specification and may convert the job specification in a Kubernetes resource form (S505). In other words, under the assumption that the corresponding job specification is a job specification already verified, the cluster agent 302 may convert the job specification in a form (e.g., a container) necessary for Kubernetes corresponding to a tool which manages a cluster. According to the above description, the cluster agent 302 may define, retrieve, and/or translate the job specification such that a Kubernetes API server 304 is capable of executing the command of the user 100 as a container.

The cluster agent 302 may generate a required resource (e.g., a workload pod or a job) through the Kubernetes API server 304.

In this case, the cluster agent 302 may request the Kubernetes API server 304 to generate a container resource (S506).

The Kubernetes API server 304 may schedule the container resource to an appropriate node in the compute cluster 300 (S507). A Kubernetes scheduler may allocate the container resource to the appropriate node in the compute cluster 300. In this case, the container resource may be allocated in the form of a Kubernetes pod. The machine learning job may be packaged to a Docker container and may be executed. A workload (e.g., a learning job, an inference service etc.) specialized for machine learning may be defined and managed by using a custom resource definition (CRD) of the Kubernetes. As an example, a computational resource such as a GPU resource may be managed through an NVIDIA Device Plugin and may be dynamically allocated if necessary.

The Kubernetes API server 304 may determine that the container resource for the cluster agent 302 is generated (S508). For example, the Kubernetes API server 304 may transmit, to the cluster agent 302, an “Ack” message indicating that the container resource is generated.

The cluster agent 302 may report, to the MLOps platform 200, that the machine learning task which the user 100 requests is allocated (S509).

According to an embodiment of the present disclosure, because the user fails to directly transfer the machine learning task command to the compute cluster 300, the user may give the machine learning task command to the compute cluster 300 through an interface such as the MLOps platform 200; in this case, the command which the user gives to the MLOps platform 200 may be transferred to the compute cluster 300 through the above process.

FIG. 6 is a sequence diagram illustrating a monitoring data collection process and a process in which monitoring data are transmitted to a machine learning operations platform, according to an embodiment of the present disclosure.

The compute cluster 300 may include a workload pod 310, a sidecar container 308, an aggregator 306, and the cluster agent 302.

In the specification, monitoring data may include logs (log data) and/or metrics (metric data). The log may include an indicator representing a machine learning process in a graph form, an indicator indicating where the workload is actually allocated or scheduled, a time required for machine learning, a characteristic or a type of output data of machine learning data, etc. The metrics may be indicators (e.g., loss and accuracy) expressed as Scalar over time while machine learning is in progress.

According to an embodiment of the present disclosure, the monitoring data generated at the workload pod 310 are not transmitted to the MLOps platform 200 in real time. That is, according to an embodiment of the present disclosure, in consideration of the burden of the machine learning operations service on the network, the monitoring data generated at the workload pod 310 are collected and stored and are then periodically transmitted to the MLOps platform 200.

Referring to FIG. 6, the workload pod 310 may generate logs or metrics (S601). The workload pod 310 may be a learning process generated by a user's request. The sidecar container 308 for log or metric collection may be distributed to the workload pod 310 together with an application container.

The sidecar container 308 may collect logs or metrics and may store the collected logs or metrics in a local temporary storage (e.g., emptyDir volume) (S602). The logs or metrics stored in the sidecar container 308, that is, the monitoring data, should be finally transmitted to the MLOps platform 200.

The sidecar container 308 may continuously monitor the logs or metrics of the application container based on a preset period (S603).

The aggregator 306 may periodically collect data collected from the sidecar container 308, that is, the monitoring data (S604). The aggregator 306 may be referred to as a “central collector” present in the compute cluster 300.

The aggregator 306 may compress and place the collected monitoring data (S605). The aggregator 306 may collect logs or metrics collected from a plurality of sidecar containers including the sidecar container 308 and may compress the collected logs or metrics in one place. The aggregator 306 may prepare efficient transmission by compressing and placing the collected monitoring data.

The aggregator 306 may transfer the compressed and placed monitoring data to the cluster agent 302 (S606). The aggregator 306 may retrieve the compressed and placed monitoring data (S607).

The cluster agent 302 may transmit the compressed and placed monitoring data to the MLOps platform 200 (S608). In an embodiment, the cluster agent 302 may fetch the compressed and placed monitoring data from the aggregator 306 based on a preset period and may then transmit the compressed and placed monitoring data thus fetched to the MLOps platform 200. In another embodiment, when the size of the compressed and placed monitoring data is larger than or equal to a preset threshold, the cluster agent 302 may fetch the compressed and placed monitoring data from the aggregator 306 and may transmit the compressed and placed monitoring data thus fetched to the MLOps platform 200.

The MLOps platform 200 or a log manager (not illustrated) of the MLOps platform 200 may verify and parse the received monitoring data (S609).

The MLOps platform 200 or the log manager of the MLOps platform 200 may store the verified and parsed monitoring data in a central storage (S610).

The MLOps platform 200 may index the monitoring data stored in the central storage (S611). The MLOps platform 200 may perform indexing on the monitoring data stored in the central storage such that the monitoring data are capable of being quickly retrieved and analyzed.

When communication between the MLOps platform 200 and the compute cluster 300 or communication between the MLOps platform 200 and the cluster agent 302 is impossible (e.g., network disconnection), the cluster agent 302 may prevent data loss through a retry mechanism. In detail, the aggregator 306 may initiate the retry mechanism, and the cluster agent 302 may receive the monitoring data from the aggregator 306.

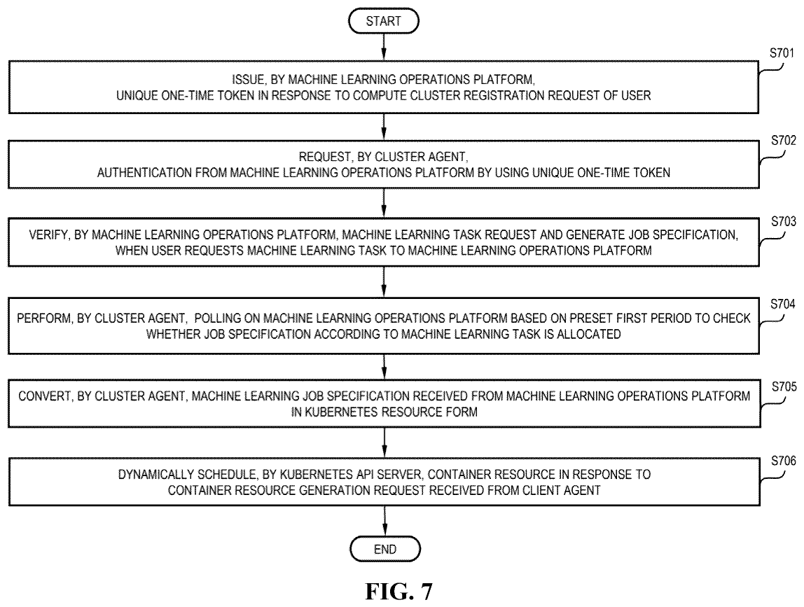

FIG. 7 is a flowchart illustrating a method for machine learning operations in a private network environment, according to an embodiment of the present disclosure.

According to a method for machine learning operations in a private network environment according to an embodiment of the present disclosure, the machine learning operations platform may issue a unique one-time token in response to a compute cluster registration request of a user (S701).

After step S701 where the unique one-time token is issued, the machine learning operations platform may transfer the unique one-time token to the user. Then, the user may install the cluster agent on a compute cluster by using the unique one-time token.

According to the method for machine learning operations in the private network environment according to an embodiment of the present disclosure, the cluster agent may request authentication from the machine learning operations platform by using the unique one-time token (S702).

At step S702 where the authentication using the unique one-time token is requested to the machine learning operations platform, when the authentication is successful, the machine learning operations platform may issue a unique certificate to the cluster agent. Afterwards, the machine learning operations platform and the cluster agent may perform mutual transport layer security (mTLS) communication based on the unique certificate.

According to the method for machine learning operations in the private network environment according to an embodiment of the present disclosure, when the user requests a machine learning task from the machine learning operations platform, the machine learning operations platform may verify the received machine learning task request and may generate a job specification according to the machine learning task request (S703).

According to the method for machine learning operations in the private network environment according to an embodiment of the present disclosure, to check whether a job specification according to the machine learning task request is assigned, the cluster agent may perform polling on the machine learning operations platform based on a preset first period (S704).

According to the method for machine learning operations in the private network environment according to an embodiment of the present disclosure, the cluster agent may convert the job specification received from the machine learning operations platform in a Kubernetes resource form (S705).

According to the method for machine learning operations in the private network environment according to an embodiment of the present disclosure, a Kubernetes API server may dynamically schedule a container resource in response to a container resource generation request received from the cluster agent (S706).

After step S706 where the container resource is dynamically scheduled, the Kubernetes API server may notify the cluster agent that the container resource corresponding to the machine learning job is generated, to the cluster agent. Afterwards, the cluster agent may report that the machine learning task is allocated.

In an embodiment, when monitoring data are generated at a workload pod, a sidecar container may monitor the monitoring data based on a preset second period. Also, the sidecar container may collect the monitoring data and may store the collected monitoring data in a temporary storage. Afterwards, an aggregator may collect the monitoring data collected and stored by the sidecar container from the sidecar container based on a preset third period. Next, the aggregator may compress and place the monitoring data collected by the aggregator.

The machine learning operations platform may receive the compressed and placed monitoring data. In addition, the machine learning operations platform may verify and parse the monitoring data thus compressed and placed. Then, the machine learning operations platform may store the compressed and placed monitoring data in a central storage. Afterwards, the machine learning operations platform may index the monitoring data thus compressed and placed.

The machine learning operations system according to an embodiment may include a machine learning operations platform configured to issue a unique one-time token in response to a compute cluster registration request of the user, to verify a received machine learning task request when the machine learning task request is received from the user, and to generate a job specification according to the machine learning task request, and a compute cluster.

The compute cluster may include a cluster agent configured to request authentication from the machine learning operations platform by using the unique one-time token, to perform polling on the machine learning operations platform based on a preset first period to determine whether the job specification according to the machine learning task request is allocated, and to convert the job specification received from the machine learning operations platform in a Kubernetes resource form, and a Kubernetes API server configured to dynamically schedule a container resource in response to a container resource generation request received from the cluster agent.

The compute cluster may be implemented with a network which permits the outbound traffic and does not permit the inbound traffic.

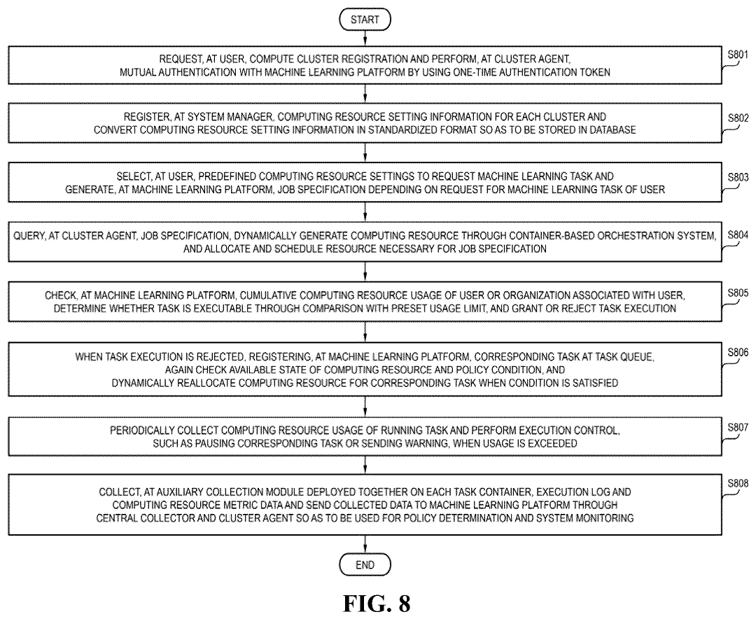

Below, various embodiments of a method for dynamic allocation and monitoring of computing resources in containerized environments for machine learning training cost optimization, which is performed by the machine learning operations system 1000, will be described with reference to FIGS. 8 to 14.

FIG. 8 is a flowchart describing a method for dynamic allocation and monitoring of computing resources in containerized environments for machine learning training cost optimization, which is performed by a machine learning operations system, according to an embodiment of the present disclosure.

According to a method for dynamic allocation and monitoring of computing resources in containerized environments for machine learning training cost optimization, according to an embodiment of the present disclosure, a user may request registration of a compute cluster, and a cluster agent installed in the compute cluster may perform mutual authentication with a machine learning platform by using a one-time authentication token (S801).

Afterwards, a system manager may register computing resource setting information for each cluster and may convert the computing resource setting information in a standardized format so as to be stored in a database (S802).

The user may select predefined computing resource settings to request a machine learning task, and the machine learning platform may generate a job specification corresponding to the machine learning task request (S803).

The cluster agent may periodically check the job specification, may dynamically generate and allocate a computing resource through the container orchestration system based on the job specification, and may schedule the corresponding machine learning task to an available node in the compute cluster (S804).

The machine learning platform may query an accumulated resource usage in units of a user or organization in real time; after the machine learning platform compares the accumulated resource usage with a preset usage limit to determine whether it is possible to dynamically allocate a resource, the machine learning platform may grant or reject task execution (S805).

When the task execution is rejected, the machine learning platform may register the corresponding task at a task queue, may periodically check an available state of the computing resource and a policy condition, and may dynamically reallocate the computing resource to the corresponding task when the condition is satisfied (S806).

The machine learning platform may periodically collect a computing resource usage of the running task, may compare the computing resource usage with the preset usage limit, and may perform execution control, such as pausing the corresponding task or transferring warning, when the computing resource usage exceeds the usage limit (S807).

An auxiliary collection module deployed together in each task container may collect execution log and computing resource metric data and may send the collected data to the machine learning platform through a central collector and the cluster agent so as to be used for policy determination and system monitoring (S808).

Additionally, the organization which registers the compute cluster may set up a resource access policy for any other organization, and the machine learning platform may grant or reject an access request of a user of the other organization depending on the corresponding resource access policy.

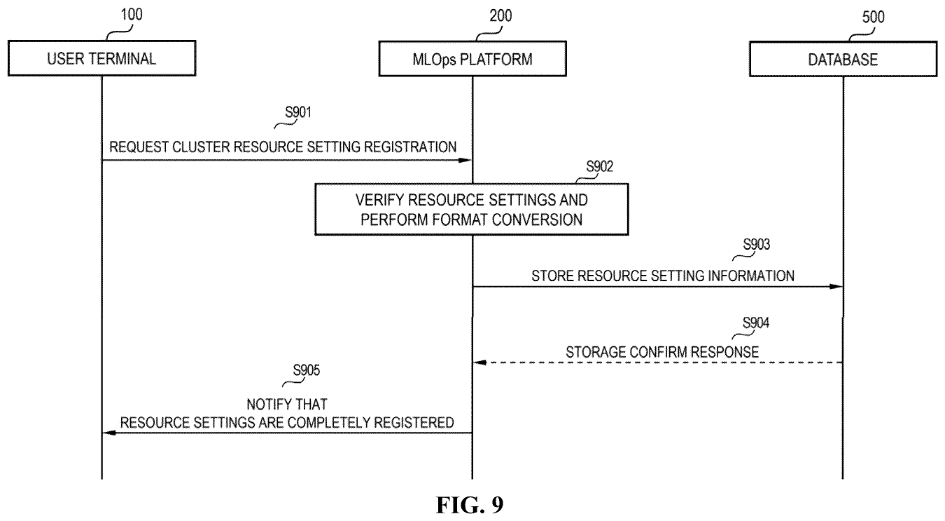

Below, embodiments associated with respective steps of a method for dynamic allocation and monitoring of computing resources in containerized environments for machine learning training cost optimization will be described in detail with reference to FIGS. 9 to 15.

Below, the description will be given under the condition that a subject of a operation of querying resource constraint information to check whether it is restricted is the MLOps platform 200 or the backend server. The description will be given under the assumption that the backend server is one component of the MLOps platform 200. However, the present disclosure is not limited thereto. For example, according to an embodiment, the backend server may be implemented to be separately built outside the MLOps platform 200.

FIG. 9 is a sequence diagram illustrating a method for registration and management of predefined resource settings for dynamic computing resource allocation, according to an embodiment of the present disclosure.

Referring to FIG. 9, the user 100 (e.g., the system manager) may connect to the MLOps platform 200 and may request registration of resource settings (e.g., “high-performance learning” or “lightweight inference”) to be applied to a specific cluster (S901).

Afterwards, the MLOps platform 200 verifies information about the registered resource settings, and when it is possible to set the resource, the MLOps platform 200 may convert the format for database storage such that the resource setting information is stored in the database 500 (S902 and S903).

When a resource storage confirm response is received from the database 500 (S904), the MLOps platform 200 may notify the user terminal 100 that the resource settings are completely registered (S905).

According to the above method, the system manager may in advance define settings (e.g., a CPU, a memory, a GPU, and a network bandwidth) associated with resource allocation for each cluster so as to be stored in the database 500.

In this way, the user may quickly allocate the machine learning task to the cluster by selecting predefined settings without a complex resource configuration process.

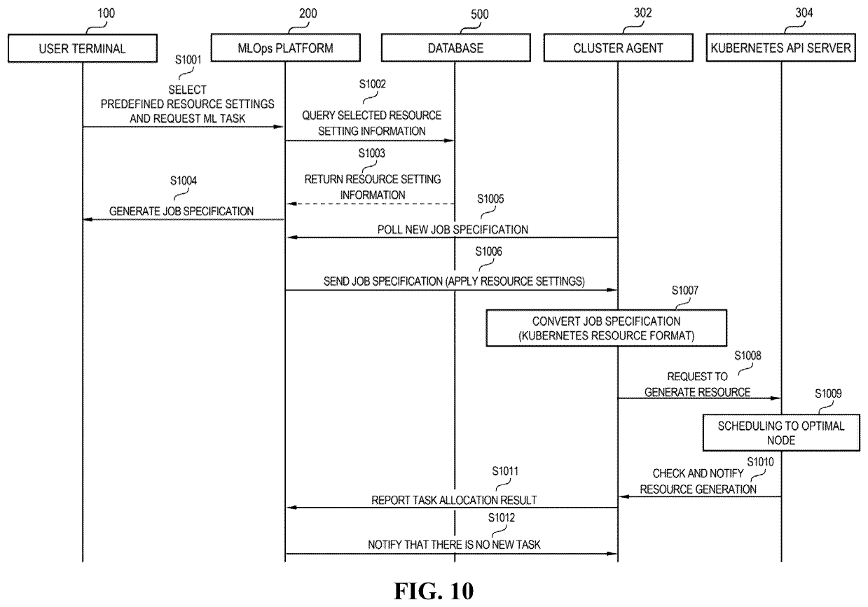

FIG. 10 is a sequence diagram illustrating a resource allocation method using predefined resource settings for dynamic computing resource allocation, according to an embodiment of the present disclosure.

Referring to FIG. 10, the user terminal 100 may select predefined resource settings through an interface (e.g., a web interface or a command-line interface (CLI)) of the MLOps platform 200 and may then submit a new machine learning task request (S1001).

The MLOps platform 200 may query the corresponding resource setting information to the database 500 (S1002) and may receive the resource setting information returned from the database 500 (S1003).

The MLOps platform 200 may generate the job specification including the received resource setting information and may return a result to the user terminal 100 (S1004).

The cluster agent 302 may periodically poll a new job specification on the MLOps platform 200 and may perform an operation corresponding to the result of polling. That is, the cluster agent 302 may periodically perform step S1005 to step S1012.

In detail, the cluster agent 302 may periodically poll a new job specification on the MLOps platform 200 (S1005); when the new job specification exists, the cluster agent 302 may be provided with the job specification from the MLOps platform 200 (S1006).

When the job specification is received, the cluster agent 302 invokes the Kubernetes API server 304 to generate a resource to be suitable for the corresponding resource settings and performs scheduling. That is, when the cluster agent 302 provides the Kubernetes API server 304 with a resource generation request complying with a Kubernetes resource format based on the job specification (S1008), and the Kubernetes API server 304 may schedule generation of the corresponding resource to an optimal node among valid nodes (S1009) and may notify the cluster agent 302 that the corresponding resource is generated (S1010).

Afterwards, the cluster agent 302 may report a task allocation result associated with the new job specification to the MLOps platform 200 (S1011).

Step S1006 to step S1011 are performed when the new job specification exists. In contrast, when a new job specification does not exist, the MLOps platform 200 may notify the cluster agent 302 that a new job specification does not exist (S1012).

Through the above process, the user may quickly allocate a machine learning task to a cluster by using predefined resource setting information. That is, when the user requests a machine learning task, the corresponding settings may be retrieved from a database and may then be applied to a job specification, and the cluster agent may generate and allocate a resource through the Kubernetes API based on the job specification. Through this process, the machine learning task may be quickly allocated to the cluster.

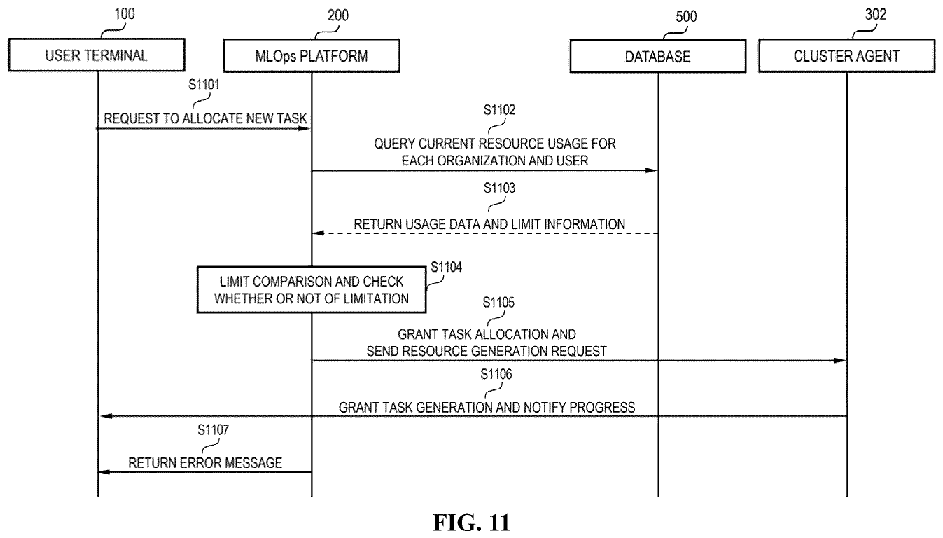

FIG. 11 is a sequence diagram illustrating a method of checking a usage limit before resource generation for dynamic computing resource allocation, according to an embodiment of the present disclosure.

Referring to FIG. 11, when the user terminal 100 submits a new task allocation request (S1101), the MLOps platform 200 may query a current resource usage for each organization and user and constraint information about the resource usage, that is, limit information on the database 500 (S1102) and may receive the found information returned from the database 500 (S1103). As an example, the limit information may include constraint information such as a maximum GPU/CPU usage time, the number of available GPUs/CPUs, a maximum workload execution time, a maximum available disk, and a total time of concurrent running workloads.

The MLOps platform 200 may compare the found information with the preset limit to determine whether it is possible to allocate a new task (S1104).

When the found information is within the limit, the MLOps platform 200 may grant the task and may send the resource generation request to the cluster agent 302 (S1105). The cluster agent 302 may provide the user with a notification for task generation approval and progress (S1106).

When the found information exceeds the limit, the MLOps platform 200 may return an error message indicating that the found information exceeds the limit, to the user terminal 100 (S1107) and may block new task allocation.

Through the above process, before a resource is generated, the backend server of the MLOps platform 200 may compare a resource usage limit set for each organization and user with a current usage and may determine whether to allocate a new task.

In an embodiment, details of constrain-possible resources may include at least one of the following items.
Maximum GPU usage time and maximum CPU usage time: a cumulative usage time of GPU and CPU capable of being allocated for a specified time period
The number of GPUs and CPUs available: the number of GPUs and CPU equipment capable of being allocated in a cluster
Maximum workload execution time: a maximum time during which a single workload is executable
Maximum available disks; a total disk capacity capable of being allocated
Total time of concurrent workloads: a cumulative execution time of concurrent workloads

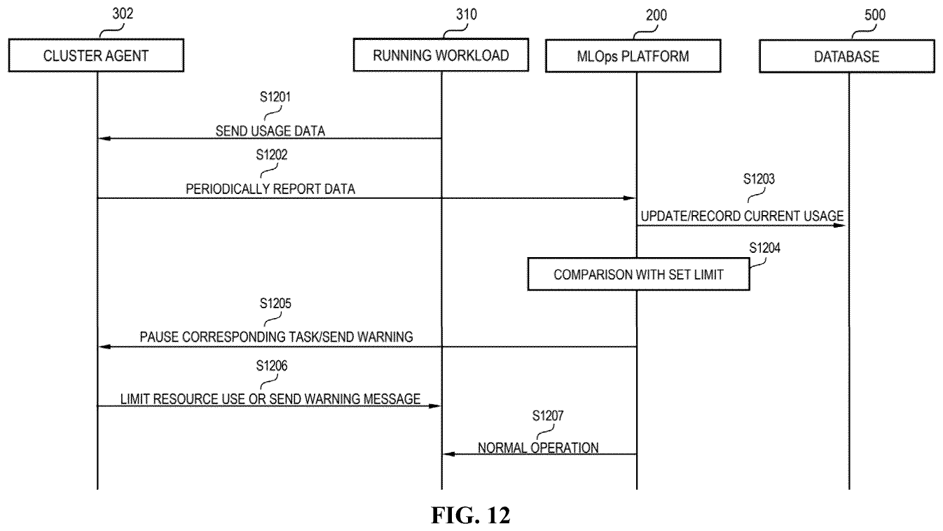

FIG. 12 is a sequence diagram illustrating a method of monitoring and limiting a workload usage for dynamic computing resource allocation, according to an embodiment of the present disclosure.

Each of running workloads 310 may periodically send its usage information, for example, execution time and resource consumption information, to the cluster agent 302 (S1201).

The cluster agent 302 may periodically report the received data to the backend server of the MLOps platform 200 (S1202). In this case, the backend server may update and record a current usage through the database 500.

In the backend server, the updated usage may be compared with the set limit (S1204). As a result of the comparison in step S1204, when the updated usage exceeds the set limit, automatic pause or warning for the corresponding task may be sent to the running workload through the cluster agent 302 (S1205 and S1206).

As a result of the comparison in step S1204, when the updated usage does not exceed the set limit, the backend server may instruct the running workload to operate normally (S1207).

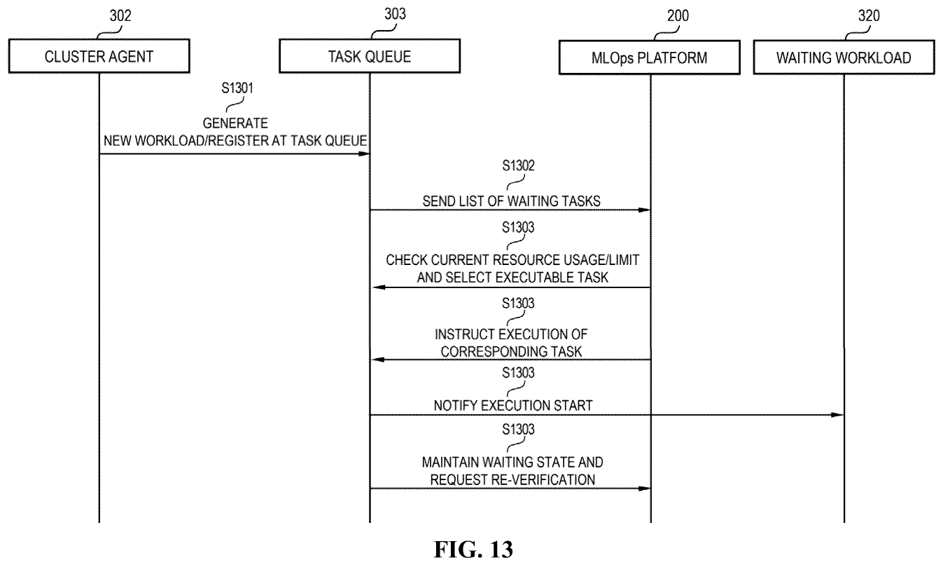

FIG. 13 is a sequence diagram illustrating a deployment waiting method using a task queue for dynamic computing resource allocation, according to an embodiment of the present disclosure.

Referring to FIG. 13, when a new workload is generated, the cluster agent 302 may register the corresponding task at a task queue, that is, a task queue 303 (S1301).

The backend server of the MLOps platform 200 may periodically query a list of waiting tasks on the task queue 303 (S1302) and may select an executable task based on current resource usage and limit information (S1303).

When the resource usage limit is satisfied, that is, when the corresponding task is executable within the resource usage limit, the backend server provides an execution command for the corresponding task to the task queue 303 (S1304). In addition, the task queue 303 notifies a waiting workload 320 that the execution of the corresponding task starts (S1305) and thus, the corresponding workload starts to execute the corresponding task.

When the resource usage limit is not satisfied, the task queue 303 may maintain a waiting state and periodically request re-verification from the backend server (S1306).

In this way, before the generated workload is actually executed, the transition to a scheduling waiting state may be made by using the task queue 303. This process may control the workload so as to be finally executed within the resource usage limit.

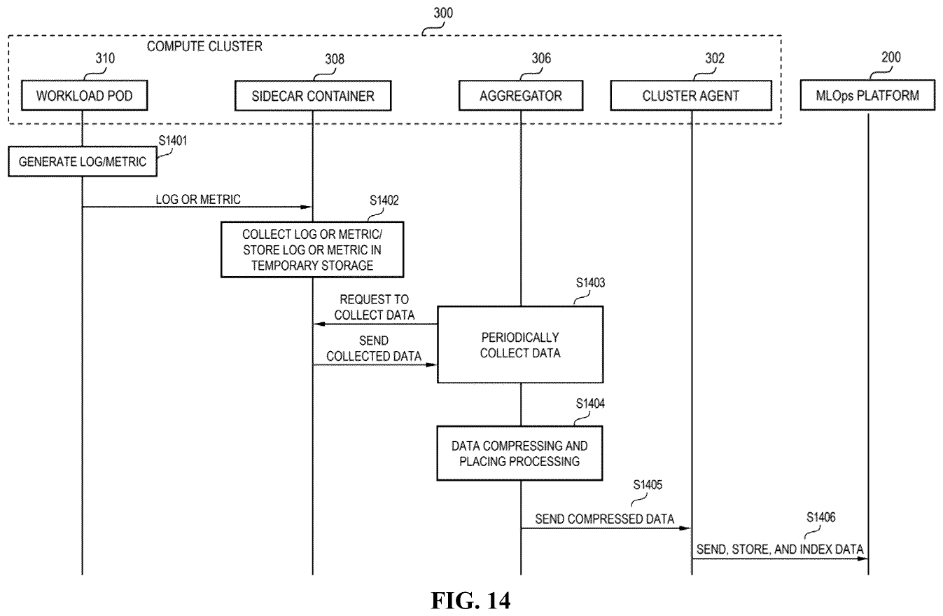

FIG. 14 is a sequence diagram illustrating a log and metric collection and transmission method for dynamic computing resource allocation, according to an embodiment of the present disclosure.

Referring to FIG. 14, the workload pod 310 may generate logs or metrics (S1401). The workload pod 310 may be a learning process generated by a user's request. The sidecar container 308 for log or metric collection may be deployed to the workload pod 310 together with an application container.

The sidecar container 308 may collect logs or metrics and may store the collected logs or metrics in local temporary storage (e.g., emptyDir volume) (S1402). The logs or metrics stored in the sidecar container 308, that is, the monitoring data, should be finally sent to the MLOps platform 200.

The sidecar container 308 may continuously monitor the logs or metrics of the application container based on a preset period (S1403).

The aggregator 306 may periodically collect data collected from the sidecar container 308, that is, the monitoring data (S1403). The aggregator 306 may be referred to as a “central collector” present in the compute cluster 300.

The aggregator 306 may compress and place the collected monitoring data (S1404). The aggregator 306 may collect logs or metrics collected from a plurality of sidecar containers including the sidecar container 308 and may compress the collected logs or metrics in one place. The aggregator 306 may prepare efficient transmission by compressing and placing the collected monitoring data.

The aggregator 306 may transfer the compressed and placed monitoring data to the cluster agent 302 (S1405). The aggregator 306 may retrieve the compressed and placed monitoring data.

The cluster agent 302 may transmit the compressed and placed monitoring data to the MLOps platform 200 (S1406). In an embodiment, the cluster agent 302 may fetch the compressed and placed monitoring data from the aggregator 306 based on a preset period and may then transmit the compressed and placed monitoring data thus fetched to the MLOps platform 200. In another embodiment, when the size of the compressed and placed monitoring data is larger than or equal to a preset threshold, the cluster agent 302 may fetch the compressed and placed monitoring data from the aggregator 306 and may transmit the compressed and placed monitoring data thus fetched to the MLOps platform 200.

As an example, the MLOps platform 200 (or, a log manager of the MLOps platform 200) may verify and parse the received monitoring data.

As an example, the MLOps platform 200 or the log manager of the MLOps platform 200 may store the verified and parsed monitoring data in central storage.

As an example, the MLOps platform 200 may index the monitoring data stored in the central storage. The MLOps platform 200 may perform indexing on the monitoring data stored in the central storage such that the monitoring data are capable of being quickly retrieved and analyzed.

As an example, when communication between the MLOps platform 200 and the compute cluster 300 or communication between the MLOps platform 200 and the cluster agent 302 is impossible (e.g., network disconnection), the cluster agent 302 may prevent data loss through a retry mechanism. In detail, the aggregator 306 may initiate the retry mechanism, and the cluster agent 302 may retrieve the monitoring data from the aggregator 306.

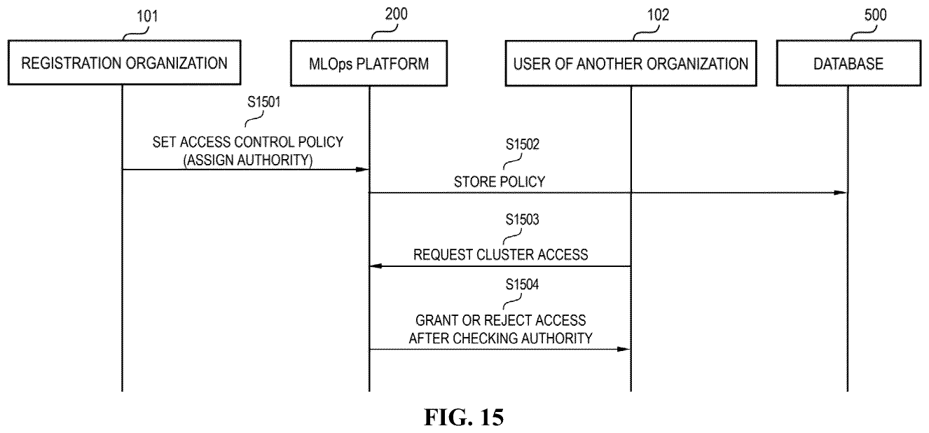

FIG. 15 is a sequence diagram illustrating an organization-specific access control method for dynamic computing resource allocation, according to an embodiment of the present disclosure. FIG. 15 is associated with a process in which a registration organization, that is, an original organization which registers a cluster, sets an access authority for any other organization.

Referring to FIG. 15, in association with the MLOps platform 200, a registration organization 101 may set an access control policy and may grant an authority (S1501); the MLOps platform 200 may store a related policy in the database 500 (S1502).

When a user 102 of any other organization requests a cluster access from the MLOps platform 200 (S1503), the MLOps platform 200 may check the authority and may then perform access permission or rejection (S1504).

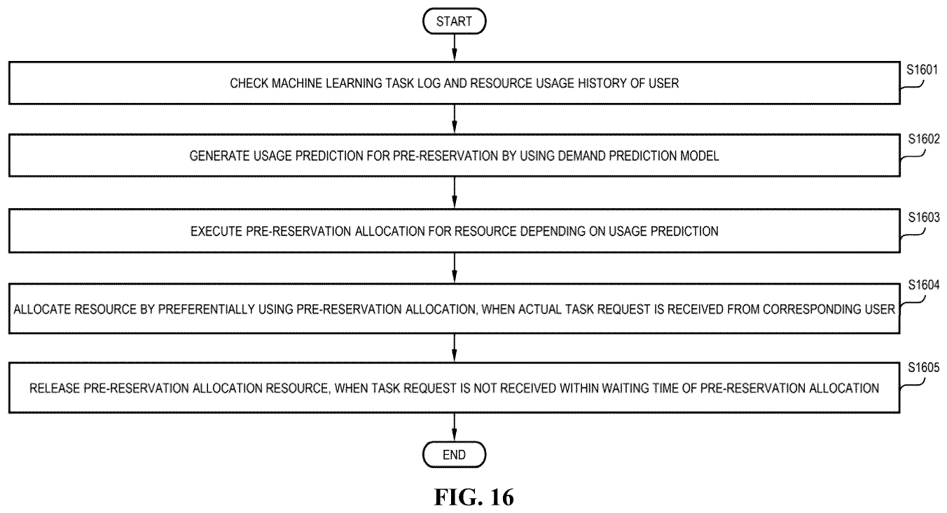

FIG. 16 is a flowchart illustrating a resource pre-reservation allocation method for dynamic computing resource allocation, according to an embodiment of the present disclosure. The resource pre-reservation allocation may be performed on the MLOps platform 200 or the backend server.

An embodiment in which a resource in a cluster is pre-reserved based on existing resource utilization data of the user before an actual task request is disclosed in FIG. 16.

Referring to FIG. 16, the backend server may check a machine learning task log and a resource usage history of the user (S1601).

For example, the backend server may collect data on a task execution cycle (e.g., 9 a.m. daily), an average resource usage (e.g., two GPUs and RAM 32 GB), and an execution time (e.g., about 2 hours) based on the task log and resource usage history of the user.

The backend server may generate usage prediction for a pre-reservation by using a demand prediction model (S1602).

In an embodiment, the backend server may include and train a long short-term memory (LSTM)-based demand prediction model.

For example, input data of the demand prediction model which are time-series data such as x=[day, time zone, user ID, organizational ID, resource type, past GPU request amount, past CPU request amount, memory request amount, etc.,] may be configured in time series based on a normalized time index.

For example, the output of the demand prediction model may be a GPU demand to be requested at the future time or a total resource request amount to be requested at the future time and may be implemented by a vector of y+1=GPU demand, y+1={GPU, CPU, Memory}, etc.

In an embodiment, the loss function of the demand prediction model may use a custom loss function based on the difference between a predicted resource amount and an actual usage as shown in Equation 1 below.

$${L}_{t} = \{ \begin{matrix}α \cdot {( {\hat{r}}_{t} - {r}_{t} )}^{2} , if {\hat{r}}_{t} > {r}_{t} ( resource over - prediction ) \\ β \cdot {( {\hat{r}}_{t} - {r}_{t} )}^{2} , if {\hat{r}}_{t} \leq {r}_{t} ( resource under - prediction )\end{matrix} \qquad [ Equation 1 ]$$

In Equation 1, the meaning of each symbol is as follows.
\hat{r}t: resource demand predicted at time point “t” (e.g., the number of GPUs)
rₜ: actual resource usage at time point “t”
α; loss weight according to over-prediction of resource
β; loss weight according to under-prediction of resource
α and β satisfy Equation 2 below.

$$α \neq β \qquad [ Equation 2 ]$$

In an embodiment, α and β may be set to satisfy Equation 3 below and may be set to impose a high penalty when prediction is excessively made.

$$α > β \qquad [ Equation 3 ]$$

The loss function may be flexibly designed to be appropriate for a cost structure and a policy objective of an actual resource allocation system, and in the case of training or fine-tuning a model based on the custom loss function, there may be provided an effect of optimizing performance in terms of operation efficiency and policy fidelity in addition to accuracy.

Afterwards, the backend server may perform pre-reservation allocation on the resource according to usage prediction (S1603).

For example, the backend server may perform reservation to the cluster agent to virtually allocate resources such as a GPU slot, a CPU, and a memory to the corresponding node before a given time (e.g., 15 minutes to 1 hour before) from the scheduled time of the pre-reservation allocation. The reserved resource may be locked so as not to be allocated to any other task during a given time.

Afterwards, when an actual task request is received from the corresponding user, the backend server may allocate a resource by preferentially using the pre-reservation allocation (S1604).

That is, when the user requests a task as predicted, the corresponding request may be immediately bound to the pre-reserved resource and thus may be executed quickly without orchestration wait.

When the actual work request is not received within the waiting time of the pre-reservation allocation, the backend server may resolve the pre-reservation allocation resource (S1605). When the task request is not received even after the reserved time, the reserved resource may be automatically released and may be placed for any other task. In this case, prediction reliability may be adjusted, and a prediction reservation priority of the corresponding user may be lowered when the release of the reserved resource is repeated the given number of times.

The machine learning operations system according to an embodiment may include a computer program which is stored in a non-transitory computer-readable recording medium coupled to a computer or a computing device, which is hardware, and performs the above steps.

The machine learning operations system according to an embodiment may be implemented with a computing device including at least one processor which executes instructions of programs loaded to a memory. A program including the instructions described to execute step S600 to step S610 of FIG. 6 described above may be loaded to the memory of the computing device.

The foregoing devices may be implemented by a hardware component, a software component, and/or a combination of a hardware component and a software component. For example, the devices and the components described in the embodiments may be implemented by using one or more general-purpose computers or special-purpose computers, like a processor, a controller, an arithmetic logic unit (ALU), a digital signal processor, a microcomputer, a field programmable gate array (FPGA), a programmable logic unit (PLU), a microprocessor, or any device which may execute instructions and may respond thereto. A processing unit may execute an operating system (OS) or one or more software applications running on the operating system. Also, the processing unit may access, store, manipulate, process, and generate data in response to the execution of software. For convenience of understanding, the description is given as a single processing unit, but it will be understood by one skilled in the art that the processing unit may include a plurality of processing elements and/or a plurality of types of processing elements. For example, the processing device may include a plurality of processors or may include one processor and one controller. Also, any other processing configuration such as a parallel processor is possible.

Software may include a computer program, a code, an instruction, or one or more combinations thereof and may constitute a processing device to operate in a desired manner or may control the processing device independently or collectively. Software and/or data may be permanently or temporarily embodied in any type of a machine, a component, physical equipment, virtual equipment, a computer storage medium, a computer device or in a transmitted signal wave, so as to be interpreted by the processing unit or to provide instructions or data to the processing unit. Software may be distributed on computer systems connected over a network so as to be stored therein or executed thereon. Software and data may be recorded in one or more computer-readable storage media.

The method according to the embodiment may be recorded in a computer-readable medium including a program instruction executable through various computer devices. The computer-readable medium may also include a program instruction, a data file, a data structure, or a combination thereof. The program instruction recorded in the medium may be designed and configured specially for the embodiment or may be known and available to one skilled in computer software. The computer-readable storage medium may include, for example, a hardware device, which is specially configured to store and execute a program instruction, such as a magnetic medium (e.g., a hard disk drive, a floppy disk or a magnetic tape), an optical medium (e.g., CD-ROM or DVD), a magneto-optical medium (e.g., a floptical disk), a read only memory (ROM), a random access memory (RAM), or a flash memory. As an example, the program instruction includes not only a machine language code created by a compiler but also a high-level language code capable of being executed by a computer by using an interpreter or the like. The hardware device may be configured to act as one or more software modules to perform the operation of the embodiment, and vice versa.

Effects according to embodiments are as follows. When a machine learning task is requested by the user, it is possible to determine whether to exceed a resource usage limit through comparison with predefined resource setting before the machine learning task is executed, and thus, unnecessary resource waste is prevented through policy-based resource allocation control.

Even though the user does not again request the task manually, as the system continuously monitors a resource state and determines re-execution, the system automatically registers the task at a task queue even when a resource is insufficient or a condition is not satisfied and induces automatic execution when a condition is satisfied. Accordingly, user convenience and system automation are improved.

Because the resource overuse is detected during task execution rather than afterward, a resource usage of a running task is monitored in real time and dynamically controlled, and warnings or restrictive measures are made in the case of violating a policy. Accordingly, the stability and equity of the overall resource operations are secured.

As task logs and resource metric data are automatically collected and are sent to the center, it is possible to improve the policy, to analyze a usage, and to establish a cost optimization strategy based on operation data.

Whether or not of an access of a user of any other organization is automatically determined depending on the policy defined by a registration organization, that is, an access control policy of an organization unit is set and applied. Accordingly, in a cluster sharing environment, it is possible to prevent resource conflicts between organizations and to strengthen security.

It is possible to provide a scalable structure suitable for a cloud-native environment and a multi-tenancy through smooth integration with a container-based orchestration system.

Effects to the present disclosure are not limited to the above effects, and effects not mentioned herein may be clearly understood from the specification and the accompanying drawings by one skilled in the art to which the present disclosure pertains.

Although the present disclosure has been described above with reference to the limited exemplary embodiments and drawings, various modifications and variations can be made from the above description by those of ordinary skill in the art. For example, even when the described techniques are performed in an order different from the method described above, and/or even when components of the described system, structure, device, circuit, and the like are coupled or combined in a form different from the way described above or replaced or substituted with other components or equivalents, an appropriate result can be achieved.

Therefore, other implementations, other embodiments, and equivalents to the claims fall within the scope of the following claims.

What is claimed is:

1. A method for dynamic allocation of a computing resource in a containerized environment for machine learning training cost optimization, which is performed by a machine learning operations system, the method comprising:
selecting, at a user, predefined computing resource settings to request a machine learning task;
generating, at a machine learning platform, a job specification depending on the request of the machine learning task;
periodically querying, at a cluster agent integrating with the machine learning platform, the job specification, dynamically generating a computing resource through a container-based orchestration system, and allocating and scheduling a resource necessary for the job specification; and
checking, at the machine learning platform, a cumulative computing resource usage of the user or an organization associated with the user in real time, determining whether the machine learning task is executable by comparing the cumulative computing resource usage with a preset usage limit, and granting or rejecting execution of the machine learning task based on a result of the determination.

2. The method of claim 1, further comprising:
when the task execution is rejected,
registering, at the machine learning platform, the machine learning task at a task queue, periodically again checking an available state of the resource and a set policy condition, and directing the execution of the machine learning task through the cluster agent when a condition is satisfied.

3. The method of claim 1, further comprising:
periodically collecting, at the machine learning platform, a resource usage of a running machine learning task, and pausing the running machine learning task or sending a warning message to the user when the collected usage exceeds the preset usage limit.

4. The method of claim 1, further comprising:
converting, at the cluster agent, the job specification in a resource format of the container-based orchestration system, and deploying a converted resource on an available node in a compute cluster.

5. The method of claim 3, further comprising:
collecting, at an auxiliary collection module deployed on a task container in the compute cluster, a task execution log and a computing resource metric so as to be sent to the cluster agent through a central collector, and sending, at the cluster agent, the task execution log and the computing resource metric to the machine learning platform.

6. The method of claim 1, further comprising:
analyzing and providing, at the machine learning platform, collected log and metric data such that the user or a manager visually checks a resource usage history and cost prediction information.

7. The method of claim 6, further comprising:
performing, at the machine learning platform, an automated resource control procedure including task queue registration, execution restriction, condition review, and scheduling, in association with a task request exceeding a resource usage limit of the user or the organization.

8. The method of claim 6, further comprising:
setting, at an organization registering a compute cluster, an access control policy for restricting or permitting a resource access of another organization to the machine learning platform; and
granting or blocking, at the machine learning platform, a task request of a user of the another organization depending on the policy.

9. A machine learning operations system which performs dynamic computing resource allocation in a containerized environment for machine learning training cost optimization, comprising:
a machine learning platform configured to receive a request for a machine learning task of a user and to generate a job specification for the machine learning task based on predefined computing resource settings;
a cluster agent configured to integrate with the machine learning platform, to periodically query the job specification, to dynamically generate a computing resource through a container-based orchestration system, and to allocate a resource necessary for the job specification so as to be scheduled to an available node of a compute cluster; and
a metric collector configured to periodically collect a resource usage state of the compute cluster so as to be sent to a backend server,
wherein the machine learning platform is configured to:
collect, in real time, information about a cumulative computing resource usage of the user or an organization to which the user belongs;
determine whether the task is executable by comparing the cumulative computing resource usage with a preset resource usage limit; and
grant or reject execution of the machine learning task based on a result of the determination.

10. A non-transitory computer-readable recording medium including instructions causing a computer to execute the method of claim 1.
